(19) United States
(12) Patent Application Publication
(10) Pub. No.: US 2026/0106331 A1
(43) Pub. Date: Apr. 16, 2026

(54) BATTERY PACK AND METHOD OF MANUFACTURING THE SAME

(71) Applicant: Samsung SDI Co., Ltd., Yongin-si (KR)

(72) Inventor: Sanghun Park, Yongin-si (KR)

(73) Assignee: Samsung SDI Co., Ltd., Yongin-si (KR)

(21) Appl. No.: 19/351,664

(22) Filed: Oct. 7, 2025

(30) Foreign Application Priority Data
Oct. 15, 2024 (KR) 10-2024-0140746

(51) Int. Cl. H01M 50/503; H01M 50/213; H01M 50/291; H01M 50/516; H01M 50/519

(52) U.S. Cl. CPC H01M 50/503; H01M 50/213; H01M 50/291; H01M 50/516; H01M 50/519

(57) ABSTRACT

Disclosed are a battery pack and a method of manufacturing the same. The battery pack may include a plurality of battery cells; an electrode tab electrically connected to terminals of one or more battery cells, among the plurality of battery cells, and having a hole formed therein which is defined at least in part by a portion of the electrode tab; and a protection circuit module having a protection circuit formed therein and including a connection tab connected to the portion of the electrode tab. The portion of the electrode tab (defining the hole) and the connection tab may be electrically connected by soldering.

### CROSS-REFERENCE TO RELATED APPLICATIONS

This present application claims priority to and the benefit under 35 U.S.C. § 119(a)-(d) of Korean Patent Application No. 10-2024-0140746, filed on Oct. 15, 2024, in the Korean Intellectual Property Office, the entire disclosure of which is incorporated herein by reference.

### FIELD

The present disclosure relates to a battery pack and a method of manufacturing the same.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as motors of hybrid vehicles or electric vehicles, and for power storage. The secondary battery may include an electrode assembly consisting of a positive electrode and a negative electrode, a case that accommodates the electrode assembly, a terminal part connected to the electrode assembly, etc.

The above information disclosed in this Background section is for enhancement of understanding of the background of the present disclosure, and therefore, it may contain information that does not constitute related (or prior) art.

### SUMMARY

Embodiments of the present disclosure are directed to providing a battery pack in which a plurality of battery cells and a protection circuit module are connected in the state in which the plurality of battery cells and the protection circuit module have been separated from each other, and a method of manufacturing the same.

However, the technical problem to be solved by the present disclosure is not limited to the problems identified herein, as other problems not mentioned herein, and aspects and features of the present disclosure that would address such problems, will be clearly understood by those skilled in the art from the description of the present disclosure herein.

A battery pack according to embodiments of the present disclosure may include a plurality of battery cells, an electrode tab electrically connected to terminals of one or more battery cells, among the plurality of battery cells, and having a hole formed therein which is defined at least in part by a portion of the electrode tab, and a protection circuit module having a protection circuit formed therein and including a connection tab connected to the portion of the electrode tab. The portion of the electrode tab and the connection tab may be electrically connected by soldering.

In embodiments, the portion of the electrode tab and the connection tab may be connected in the state in which the plurality of battery cells and the protection circuit module have been separated from each other.

In embodiments, a mounting surface on which a plurality of chips of the protection circuit module is mounted may be disposed toward the plurality of battery cells.

In embodiments, an interval between the plurality of battery cells and the protection circuit module may be greater than the height of a chip having a maximum height, among the plurality of chips.

In embodiments, a first soldering area that connects the protection circuit module and the connection tab may be formed on a surface opposite to the mounting surface of the protection circuit module.

In embodiments, the electrode tab may include a first metal tab connected to the battery cell bent once in the length direction of the battery cell and bent again in the circumferential direction of the battery cell.

In embodiments, the connection tab may include a second metal tab connected to the protection circuit module bent once in the thickness direction of the protection circuit module and bent again in the length direction of the protection circuit module.

In embodiments, a second soldering area that connects the portion of the electrode tab and the connection tab may be formed between the length direction of the battery cell and the length direction of the protection circuit module.

In embodiments, the electrode tab may be electrically connected to the terminals of the one or more battery cells, among the plurality of battery cells, by soldering.

In embodiments, the plurality of battery cells may be mounted on a spacer that has a shape corresponding to a lateral shape of a mounted battery cell and that supports the sides of the plurality of battery cells.

In embodiments, each of the plurality of battery cells may be a cylindrical secondary battery.

A method of manufacturing a battery pack according to embodiments of the present disclosure may include providing a plurality of cells, electrically connecting an electrode tab in which a hole has been formed, which is defined at least in part by a portion of the electrode tab, and terminals of one or more battery cells, among the plurality of battery cells, and connecting a connection tab of a protection circuit module having a protection circuit formed therein and including a connection tab and the portion of the electrode tab. The connecting of the connection tab and the portion of the electrode tab may include electrically connecting the portion of the electrode tab and the connection tab by soldering.

In embodiments, the connecting of the connection tab and the portion of the electrode tab may include connecting the portion of the electrode tab and the connection tab in the state in which the plurality of battery cells and the protection circuit module have been separated from each other.

In embodiments, the connecting of the connection tab and the portion of the electrode tab may include connecting the portion of the electrode tab and the connection tab in the state in which a mounting surface on which a plurality of chips of the protection circuit module is mounted has been disposed toward the plurality of battery cells.

In embodiments, the method of manufacturing a battery pack may further include connecting the protection circuit module and the connection tab by soldering so that a first soldering area is formed on a surface opposite to the mounting surface of the protection circuit module.

In embodiments, the method of manufacturing a battery pack may further include forming the electrode tab by bending a first metal tab connected to the battery cell once in the length direction of the battery cell and bending the first metal tab once again in the circumferential direction of the battery cell.

In embodiments, the method of manufacturing a battery pack may further include forming the electrode tab by bending a second metal tab connected to the protection circuit module once in the thickness direction of the protection circuit module and bending the second metal tab once again in the length direction of the protection circuit module.

In embodiments, the connecting of the connection tab and the portion of the electrode tab may include connecting the portion of the electrode tab and the connection tab by soldering so that a second soldering area is formed between the length direction of the battery cell and the length direction of the protection circuit module.

In embodiments, the electrically connecting of the electrode tab to the terminals of the one or more battery cells, among the plurality of battery cells, may include electrically connecting the electrode tab and the terminals of the one or more battery cells, among the plurality of battery cells, by soldering.

In embodiments, the providing of the plurality of cells may include mounting the plurality of battery cells on a spacer having a shape corresponding to a lateral shape of a mounted battery cell and supporting the sides of the plurality of battery cells.

According to embodiments of the present disclosure, workability can be improved because a soldering area is formed outside the protection circuit module by connecting the plurality of battery cells and the protection circuit module in the state in which the plurality of battery cells and the protection circuit module have been separated from each other.

According to embodiments of the present disclosure, a separation distance between a chip mounted on the protection circuit module and the plurality of battery cells can be secured and the occurrence of a failure attributable to a lead ball can be reduced because a soldering area can be avoided from being formed in the protection circuit module.

According to embodiments of the present disclosure, the battery pack can have a more compact structure because the mounting surface on which a plurality of chips of the protection circuit module is mounted is disposed toward the plurality of battery cells and the mounting surface is directed toward the inside of the battery pack.

According to embodiments of the present disclosure, stable soldering quality can be secured and sufficient location fixing power can be secured because the surface area of soldering is thinly formed by forming a soldering area between the length direction of the battery cell and the length direction of the protection circuit module.

However, aspects and features of the present disclosure are not limited to those described above, and other aspects and features not mentioned will be clearly understood by a person skilled in the art from the detailed description, described herein.

### BRIEF DESCRIPTION OF THE DRAWINGS

The following drawings accompanying this specification illustrate preferred embodiments of the present disclosure and help to further understand the technical spirit of the present disclosure along with the aforementioned contents of the disclosure. Accordingly, the present disclosure should not be construed as being limited to only contents described in such drawings:

FIG. 1A is an upper perspective view of a cylindrical secondary battery.

FIG. 1B is a cross-sectional view of the cylindrical secondary battery.

FIG. 2A is a perspective view of a battery pack according to embodiments of the present disclosure.

FIG. 2B is a front view of the battery pack according to embodiments of the present disclosure.

FIG. 2C is a side view of the battery pack according to embodiments of the present disclosure.

FIG. 3A is an enlarged perspective view of a connection part of the electrode tab and protection circuit module of the battery pack according to embodiments of the present disclosure.

FIG. 3B is an enlarged side view of a connection part of the electrode tab of the battery pack and the protection circuit module according to embodiments of the present disclosure.

FIG. 4 is an enlarged view of the electrode tab of the battery pack according to embodiments of the present disclosure.

FIG. 5 is an enlarged view of a connection tab of the protection circuit module of the battery pack according to embodiments of the present disclosure. FIGS. 6A and 6B are diagrams for describing a method of connecting the connection tab of the protection circuit module of the battery pack to the protection circuit module according to embodiments of the present disclosure.

FIG. 7 is a flowchart illustrating a method of manufacturing a battery pack according to embodiments of the present disclosure.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own technology in the most suitable way possible. Accordingly, since the embodiments described in this specification and the configurations illustrated in the drawings are only examples of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but it can also be indirectly “connected”, “coupled”, or “joined” to the other element with other elements interposed therebetween.

As used herein, the term “and/or” includes any and all combinations of one or more of the associated listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C“, ”at least one selected from the group of A, B, and C“, or ” at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed herein may be termed a second element, component, region, layer, or section without departing from the teachings of exemplary embodiments. For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below”may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is generally applicable to a prismatic secondary battery. Therefore, the cylindrical secondary battery will be briefly described prior to description of embodiments of the present disclosure.

In a battery pack constructed by using a secondary battery, in order to supply stable power to a main system of a device that is connected in or to each of a plurality of battery cells, a connection between the plurality of battery cells and a protection circuit module is essential. A method that is mostly commonly used in the connection between the plurality of battery cells and the protection circuit module is soldering. In this circumstance, if a soldering area is formed in the protection circuit module, workability is reduced, and there is a concern of occurring a failure attributable to a lead ball.

Embodiments of the present disclosure are directed to providing a battery pack in which a plurality of battery cells and a protection circuit module are connected in the state in which the plurality of battery cells and the protection circuit module have been separated from each other, and a method of manufacturing the same.

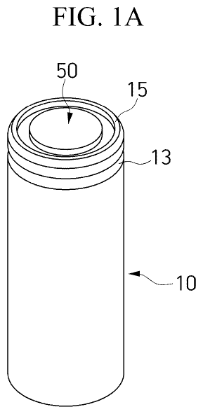

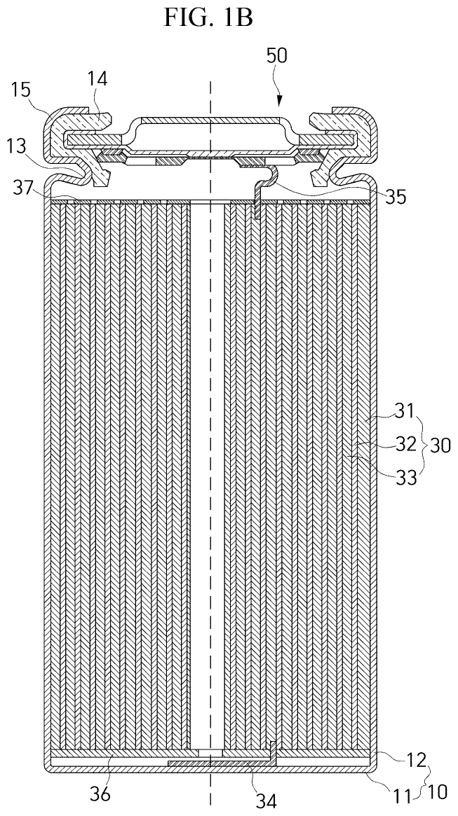

FIG. 1A is an upper perspective view of a cylindrical secondary battery.

FIG. 1B is a cross-sectional view of the cylindrical secondary battery.

Referring to FIGS. 1A and 1B, the cylindrical secondary battery may include an electrode assembly 30, a case 10 that accommodates the electrode assembly 30 and an electrolyte therein, a cap assembly 50 that is connected to an opening of the case 10 and that seals the case 10, and an insulating plate 37 disposed between the electrode assembly 30 and the cap assembly 50 within the case 10.

The electrode assembly 30 may include a separator 32 and a first electrode 33 and second electrode 31 with the separator 32 interposed between and may be wound in a jelly-roll form.

The first electrode 33 may include a first base and a first active material layer disposed in or on the first base. A first lead tap 35 may be extended from a first uncoated part that belongs to the first base and in which the first active material layer is not disposed to the outside. The first lead tap 35 may be electrically connected to the cap assembly 50.

The second electrode 31 may include a second base and a second active material layer disposed in or on the second base. A second lead tap 34 may be extended from a second uncoated part that belongs to the second base and in which the second active material layer is not disposed to the outside. The second lead tap 34 may be electrically connected to the case 10. The first lead tap 35 and the second lead tap 34 may be extended in opposite directions.

The first electrode 33 may function as a positive electrode. In this circumstance, the first base may be composed of aluminum (Al) foil, for example. The first active material layer may include transition metal oxide, for example. The second electrode 31 may function as a negative electrode. In this circumstance, the second base may be composed of copper foil or nickel foil, for example. The second active material layer may include graphite, for example. The separator 32 may function to permit a movement of lithium ions and to prevent the short-circuit of the first electrode 33 and the second electrode 31. The separator 32 may be composed of a polyethylene film, a polypropylene film, or a polyethylene-polypropylene film, for example. The case 10 may accommodate the electrode assembly 30 and an electrolyte and may form an external form of the battery along with the cap assembly 50. The case 10 may include a body part 12 having an approximately cylindrical shape and a bottom part 11 connected to one side of the body part 12. A beading part 13 that has been deformed toward the inside of the body part 12 may be disposed in the body part 12. A crimping part 15 that has been bent toward the inside of the body part 12 may be disposed at an end of the body part 12 on an opening side (of the opening).

The beading part 13 may suppress a movement of the electrode assembly 30 within the case 10 and may facilitate the settlement of a gasket 14 and the cap assembly 50. The crimping part 15 may firmly fix the cap assembly 50 by pressurizing an edge of the cap assembly 50 through the gasket 14. The case 10 may be made of iron plated with nickel, for example.

The cap assembly 50 may seal the case 10 by being fixed to the inside of the crimping part 15 through the gasket 14. The cap assembly 50 may include a cap-up part, a safety vent, a cap-down part, an insulating member, and a sub-plate, but the present disclosure is not limited to such examples. The cap assembly 50 may be variously deformed.

The cap-up part may be disposed at the top of the cap assembly 50. The cap-up part may include a terminal part that protrudes upward convexly and that is connected to an external circuit. An output for discharging a gas around the terminal part may be disposed in the cap-up part.

The safety vent may be disposed under the cap-up part. The safety vent may include a protruding part that protrudes downward convexly and that is connected to the sub-plate, and at least one notch disposed around the protruding part.

When a gas is generated due to over-charging or an abnormal operation of the secondary battery, the protruding part may be deformed upward by the pressure of the gas and separated from the sub-plate. Furthermore, the safety vent may be cut along the notch. The cut safety vent can prevent the explosion of the secondary battery by discharging the gas to the outside.

The cap-down part may be disposed under the safety vent. A first opening for exposing the protruding part of the safety vent and a second opening for discharging a gas may be disposed in the cap-down part. The insulating member may be disposed between the safety vent and the cap-down part, and may insulate the safety vent and the cap-down part.

The sub-plate may be disposed under the cap-down part. The sub-plate may be fixed to the bottom of the cap-down part in order to close the first opening of the cap-down part. The protruding part of the safety vent may be fixed to the sub-plate. The first lead tap 35 that has been withdrawn from the electrode assembly 30 may be fixed to the sub-plate. Accordingly, the cap-up part, the safety vent, the cap-down part, and the sub-plate may be electrically connected to the first electrode 33 of the electrode assembly 30.

The insulating plate 37 may be disposed to adjoin the electrode assembly 30 under the beading part 13. A tap opening for withdrawing the first lead tap 35 may be provided in the insulating plate 37. The cap assembly 50 that has been electrically connected to the first electrode 33 by the first lead tap 35 may face the electrode assembly 30 with the insulating plate 37 interposed therebetween. The cap assembly 50 may maintain the state in which the cap assembly 50 has been insulated from the electrode assembly 30 by the insulating plate 37. The cylindrical secondary battery may include another insulating plate 36 for insulation between the electrode assembly 30 and the bottom part 11 of the case 10.

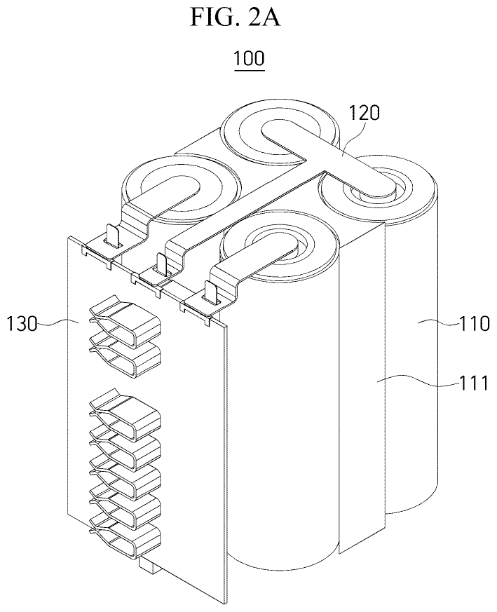

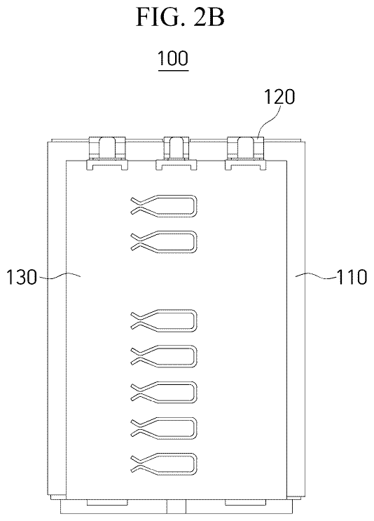

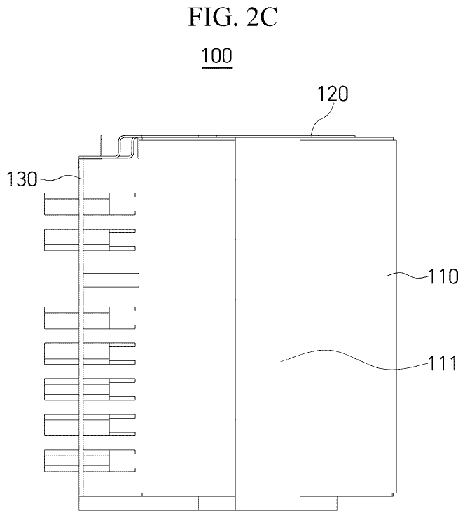

FIG. 2A is a perspective view of a battery pack according to embodiments of the present disclosure. FIG. 2B is a front view of the battery pack according to embodiments of the present disclosure. FIG. 2C is a side view of the battery pack according to embodiments of the present disclosure.

Referring to FIGS. 2A to 2C, a battery pack 100 according to embodiments of the present disclosure may include a plurality of battery cells 110, an electrode tab 120, and a protection circuit module 130.

The plurality of battery cells 110 may each be the cylindrical secondary battery described with reference to FIGS. 1A and 1B. In FIGS. 2A to 2C, a circumstance in which the number of battery cells 110 is four has been exemplarily illustrated, but the number of battery cells 110 or a connection method thereof may be changed depending on an applied device. Although the number of battery cells 110 or the connection method can be changed, the battery pack 100 according to embodiments of the present disclosure may be applied without any change such as without a change in the technical spirit of the present disclosure.

In embodiments, the plurality of battery cells 110 may be mounted on a spacer 111 that has a shape corresponding to a lateral shape of a mounted battery cell 110 and that supports the sides of the plurality of battery cells 110. In embodiments, the battery cell 110 may be a cylindrical secondary battery. Accordingly, the spacer 111 may have a lateral shape having an arc shape in accordance with a lateral shape of the battery cell 110. The spacer 111 may play a role of supporting the side of the battery cell 110 and absorbing an impact as the battery cell 110 is inserted into the spacer. In embodiments, the spacer 111 is made of an insulating material, and may be made of polymer resin, such as polyethylene (PE), polypropylene (PP), polyvinyl chloride (PVC), polystyrene (CPS), polyethylene terephthalate (PETE), polycarbonate (PC), or polyacrylonitrile-butadiene-styrene (ABS) that has electrical insulation and that is light and heat-resistant, for example. However, the spacer 111 according to embodiments of the present disclosure is not limited to such materials and may include various materials as substances having electrical insulation.

The electrode tab 120 may include an electrical connection member for electrically connecting the plurality of battery cells 110. The electrode tab 120 may electrically connect the plurality of battery cells 110 in order to connect the plurality of battery cells 110 in series or in parallel. In embodiments, the electrode tab 120 may be electrically connected to the terminals of one or more cells, among the plurality of battery cells 110, by soldering the electrode tab and the terminals. The material of the electrode tab 120 can be a metal material having excellent conductivity, and may be formed of at least one material selected among nickel, aluminum, copper, and silver materials, for example. However, the electrode tab 120 according to embodiments of the present disclosure is not limited to such materials, and may include various materials as substances having conductivity.

One or more of the plurality of electrode tabs 120 may be inserted and integrally formed in the spacer 111. In embodiments, the spacer 111 may be formed by insert-injecting the electrode tab 120 to be inserted into the spacer 111. In this circumstance, the insert injection denotes an injection process method of injecting and processing a raw material in the state in which an insert (e.g., an external element or part) is present within a mold in order to improve the strength, function, and appearance of a part.

According to embodiments of the present disclosure, coupling strength can be increased when the battery cell 110 is mounted because binding power between the spacer 111 and the electrode tab 120 is increased by integrating the spacer 111 and the electrode tab 120.

According to embodiments of the present disclosure, the volume of the battery pack 100 can be reduced because an integrated portion of the spacer 111 and the electrode tab 120 is optimized.

The protection circuit module 130 has a protection circuit formed therein, and may play a role of blocking overcharge, overdischarge, and an overcurrent of the battery cell 110 in advance. The protection circuit module 130 may be connected to the plurality of battery cells 110 in order to supply stable power to a main system of a device that is connected in each battery cell.

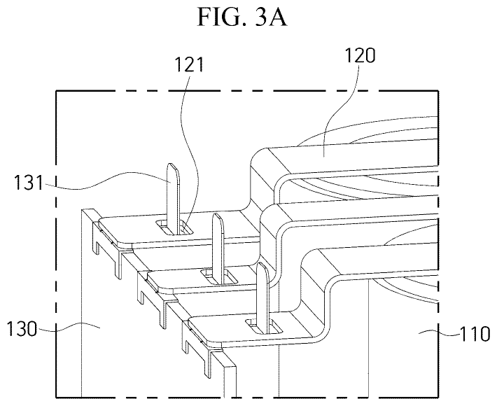

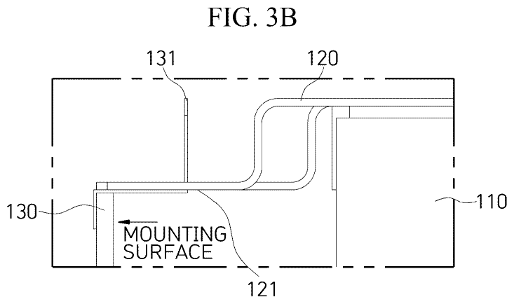

In the battery pack 100 according to embodiments of the present disclosure, the plurality of battery cells 110 and the protection circuit module 130 may be connected in the state in which the plurality of battery cells 110 and the protection circuit module 130 have been separated from each other. Hereinafter, a structure in which the plurality of battery cells 110 and the protection circuit module 130 are connected in the state in which the plurality of battery cells 110 and the protection circuit module 130 have been separated from each other is described in detail with reference to FIGS. 3A and 3B.

FIG. 3A is an enlarged perspective view of a connection part of the electrode tab and protection circuit module of the battery pack according to embodiments of the present disclosure. FIG. 3B is an enlarged side view of a connection part of the electrode tab of the battery pack and the protection circuit module according to embodiments of the present disclosure.

Referring to FIGS. 3A and 3B, the electrode tab 120 may have a hole 121 formed therein, which is defined at least in part by a portion of the electrode tab. The protection circuit module 130 may include a connection tab 131 connected to the hole 121. In embodiments, the hole 121 and the connection tab 131 may be electrically connected by soldering. The connection of the hole and connection tab may include connecting the connection tab and a portion of the electrode tab the defines, at least in part, the hole 121. The portion of the electrode tab may be a portion of a side surface of the hole 121. In this circumstance, the connection tab 131 and the hole 121 (or the portion of the electrode tab defining at least in part the hole) may be soldered in the state in which the connection tab 131 has been inserted into the hole 121. Accordingly, the battery pack according to embodiments of the present disclosure may have a structure in which the hole 121 (or the portion of the electrode tab defining at least in part the hole) and the connection tab 131 are connected in the state in which the plurality of battery cells 110 and the protection circuit module 130 have been separated from each other.

Referring to FIG. 3B, a mounting surface on which a plurality of chips of the protection circuit module 130 is mounted may be disposed toward the plurality of battery cells 110. In embodiments, an interval between the plurality of battery cells 110 and the protection circuit module 130 may be greater than the height of a chip having a maximum height, among the plurality of chips. When the interval between the plurality of battery cells 110 and the protection circuit module 130 is smaller than the height of the chip mounted on the protection circuit module 130, the battery cell 110 may come into contact with the chip. The protection circuit module 130 may construct the battery pack 100 as a structure that protects a mounted chip against external vibration or impact and that is compact because the mounting surface is directed toward the inside of the battery pack.

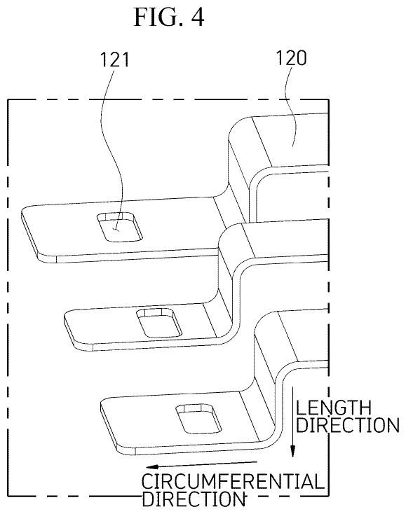

According to embodiments of the present disclosure, the plurality of battery cells 110 and the protection circuit module 130 are connected in the state in which the plurality of battery cells 110 and the protection circuit module 130 have been separated from each other. Accordingly, workability can be improved because a soldering area is formed outside the protection circuit module 130. Hereinafter, a structure of the connection tab 131 of the electrode tab 120 and the protection circuit module 130 is described in detail with reference to FIGS. 4 to 6B.

FIG. 4 is an enlarged view of the electrode tab of the battery pack according to embodiments of the present disclosure.

Referring to FIG. 4, the hole 121 may be formed in the electrode tab 120 of the battery pack according to embodiments of the present disclosure. In embodiments, the electrode tab 120 may be formed by bending a first metal tab connected to the battery cell 110 twice. For example, the electrode tab 120 may be formed by bending the first metal tab once in the length direction of the battery cell 110 and bending the first metal tab once again in the circumferential direction of the battery cell 110. In the circumstance of the battery pack 100 having a relatively low capacity, the electrode tab 120 may be formed by bending the first metal tab a plurality of times as illustrated in FIG. 4 in order to make identical the length of the protection circuit module 130 which is formed to be shorter than the length of the battery cell 110 because the length of the protection circuit module 130 is formed to be shorter than the length of the battery cell 110.

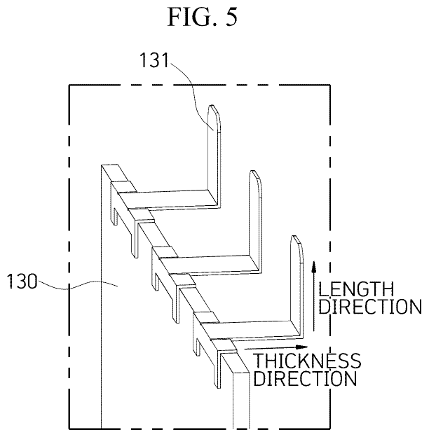

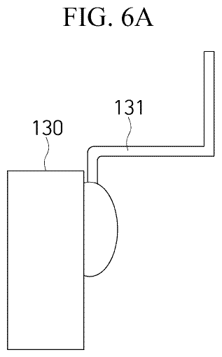

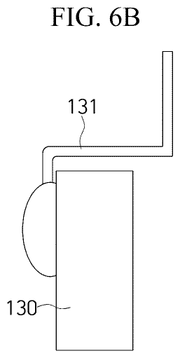

FIG. 5 is an enlarged view of the connection tab of the protection circuit module of the battery pack according to embodiments of the present disclosure. Referring to FIG. 5, the protection circuit module 130 of the battery pack according to embodiments of the present disclosure may include the connection tab 131. In embodiments, the connection tab 131 may be formed by bending a second metal tab connected to the protection circuit module 130 twice. For example, the connection tab 131 may be formed by bending the second metal tab once in the thickness direction of the protection circuit module 130 and bending the second metal tab once again in the length direction of the protection circuit module 130. In the battery pack according to embodiments of the present disclosure, the hole 121 and the connection tab 131 may be soldered in the state in which the connection tab 131 has been inserted into the hole 121. The connection tab 131 may be formed by being bent a plurality of times as illustrated in FIG. 5 because the connection tab 131 may need to be inserted into the hole 121 in a direction perpendicular to the electrode tab 120, that is, in the length direction of the protection circuit module 130, in order to insert the connection tab 131 into the hole 121.

Hereinafter, a method of connecting the connection tab 131 of the protection circuit module 130 of the battery pack 100 according to embodiments of the present disclosure to the protection circuit module 130 is described with reference to FIGS. 6A and 6B.

FIGS. 6A and 6B are diagrams for describing a method of connecting the connection tab of the protection circuit module of the battery pack to the protection circuit module according to embodiments of the present disclosure.

Referring to FIG. 6A, conventionally, the soldering area of the protection circuit module 130 and the connection tab 131 is formed in a direction toward the battery cell 110 on the right side of FIG. 6A. The height of the chip mounted on the protection circuit module 130 may not exceed a maximum of 1.3 mm . However, if a battery pack is manufactured by soldering, the battery back can be designed by securing an interval of about 2 mm or more between the battery cell 110 and the protection circuit module 130 because it is difficult to adjust the height of lead acid. For this reason, there is a problem in that an unnecessary space needs to be secured within the battery pack. If the chips are disposed toward the battery cell 110, there is a problem in that a failure may occur due to a lead ball because the soldering area and the chips are formed on the same surface.

Referring to FIG. 6B, a first soldering area that connects the protection circuit module 130 and connection tab 131 of the battery pack 100 according to embodiments of the present disclosure may be formed on a surface opposite to the mounting surface of the protection circuit module 130. Accordingly, it is not necessary, as previously, to secure a space between the battery cell 110 and the protection circuit module 130 by considering the height of lead acid, and only the height of a chip having a maximum height needs to be considered. Accordingly, the battery pack 100 having a compact structure can be constructed because an unnecessary space is not wasted. Furthermore, the occurrence of a failure attributable to the lead ball can be reduced because the soldering area and the chips are formed on different surfaces.

Referring back to FIGS. 3A and 3B, in the structure of the electrode tab 120 and protection circuit module 130 of the battery pack 100 according to embodiments of the present disclosure, a second soldering area that connects the hole 121 of the electrode tab 120 and the connection tab 131 may be formed between the length direction of the battery cell 110 and the length direction of the protection circuit module 130. Accordingly, the battery pack 100 according to embodiments of the present disclosure can secure stable soldering quality and can secure sufficient location fixing power because a wide soldering surface area is constructed.

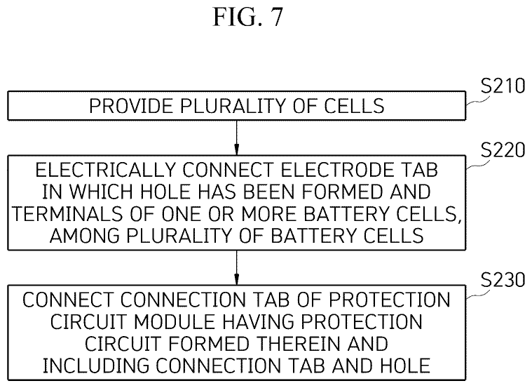

FIG. 7 is a flowchart for describing a method of manufacturing a battery pack according to embodiments of the present disclosure.

As illustrated in FIG. 7, the method of manufacturing a battery pack according to embodiments of the present disclosure may include step S210 to step S230.

Step S210 may be a step of providing the plurality of cells. In embodiments, step S210 may include a step of mounting the plurality of battery cells on the spacer that has a shape corresponding to a lateral shape of a mounted battery cell and that supports the sides of the plurality of battery cells.

Step S220 may be a step of electrically connecting the electrode tab, in which the hole has been formed, and the terminals of one or more battery cells, among the plurality of battery cells. In embodiments, step S220 may include a step of electrically connecting the electrode tab and the terminals of one or more battery cells, among the plurality of battery cells, by soldering.

Step S230 may be a step of connecting the connection tab of the protection circuit module having the protection circuit formed therein and including the connection tab and the hole. In embodiments, step S230 may include a step of electrically connecting the hole and the connection tab by soldering the hole and the connection tab. In some embodiments, step S230 may include a step of connecting the hole and the connection tab in the state in which the plurality of battery cells and the protection circuit module have been separated from each other. In some embodiments, step S230 may include a step of connecting the hole and the connection tab in the state in which the mounting surface on which the plurality of chips of the protection circuit module has been disposed toward the plurality of battery cells.

The method of manufacturing a battery pack according to embodiments of the present disclosure has been described with reference to the flowchart(s) presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 7, each of the steps may be further divided into additional steps or the steps may be coupled into smaller steps depending on an implementation example of the present disclosure.

Furthermore, some of the steps may be omitted, if necessary, and the sequence of the steps may be changed. Furthermore, the contents of FIGS. 1A to 6B, although some contents are omitted, may be applied to the contents of FIG. 7. Furthermore, the contents of FIG. 7 may be applied to the contents of FIGS. 1A to 6B.

Hereinafter, materials which may be used in a secondary battery according to embodiments of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O₂-_{c}D_{c} (0.90≤a≤1.8,0≤b≤0.5,0≤c≤0.05); LiₐMn_{2-b}X_{b}O_{4-c}D_{c} (0.90 ≤a≤1.8,0≤b≤0.5, 0≤c≤0.05); LiₐNi_{1-b}-_{c}CO_{b}X_{c}O₂₋ₐD_{α (}0.90≤a≤1.8,0<b≤0.5,0≤c≤0.5,0<a<2); LiₐNi_{1 -b-c}Mn_{b}X_{c}O₂-αD_{60 (}0.90≤a≤1.8, 0<b≤0.5, 0≤<0.5, 0<α<2); LiₐNi_{b}Co_{c}L¹_{d}GₑO₂ (0.90≤a≤1.8,0 ≤b≤0.9, 0≤c≤0.5, 0≤d≤0.5, 0≤e≤0.1); LiₐNiG_{b}O₂(0.90≤a≤1.8, 0.001≤b ≤0.1); LiₐCoG_{b}O₂(0.90≤a≤1.8, 0.001≤b≤0.1); LiₐMn_{1-b}G_{b}O₂ (0.90≤a≤1.8, 0.001 ≤b≤0.1); LiₐMn₂G_{b}O₄(0.90≤a≤1.8,0.001≤b≤0.1); LiₐMn_{1-g}G_{g}PO₄ (0.90≤a≤1.8, 0≤g≤0.5); Li(_{3-f})Fe₂(PO₄)₃(0≤f≤2); and LiₐFePO₄ (0.90≤a≤1.8). In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0≤x≤2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material and may further include a binder and/or a conductive material.

For example, the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity. One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move. The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described in connection with the exemplary embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A battery pack comprising:
a plurality of battery cells;
an electrode tab electrically connected to terminals of one or more battery cells of the plurality of battery cells, the electrode tab having a hole formed therein which is defined at least in part by a portion of the electrode tab; and
a protection circuit module having a protection circuit formed therein and comprising a connection tab connected to the portion of the electrode tab, wherein the portion of the electrode tab and the connection tab are electrically connected by soldering.

2. The battery pack as claimed in claim 1, wherein the portion of the electrode tab and the connection tab are connected in a state in which the plurality of battery cells and the protection circuit module have been separated from each other.

3. The battery pack as claimed in claim 2, wherein a mounting surface on which a plurality of chips of the protection circuit module is mounted is disposed toward the plurality of battery cells.

4. The battery pack as claimed in claim 3, wherein an interval between the plurality of battery cells and the protection circuit module is greater than a height of a chip having a maximum height, among the plurality of chips.

5. The battery pack as claimed in claim 3, wherein a first soldering area that connects the protection circuit module and the connection tab is formed on a surface opposite to the mounting surface of the protection circuit module.

6. The battery pack as claimed in claim 1, wherein the electrode tab comprises a first metal tab connected to a battery cell, the first metal tab bent once in a length direction of the battery cell and bent again in a circumferential direction of the battery cell.

7. The battery pack as claimed in claim 6, wherein the connection tab comprises a second metal tab connected to the protection circuit module, the second metal tab bent once in a thickness direction of the protection circuit module and bent again in a length direction of the protection circuit module.

8. The battery pack as claimed in claim 7, wherein a second soldering area that connects the portion of the electrode tab and the connection tab is formed between the length direction of the battery cell and the length direction of the protection circuit module.

9. The battery pack as claimed in claim 1, wherein the electrode tab is electrically connected to the terminals of the one or more battery cells, among the plurality of battery cells, by soldering.

10. The battery pack as claimed in claim 1, wherein the plurality of battery cells is mounted on a spacer that has a shape corresponding to a lateral shape of a mounted battery cell and that supports sides of the plurality of battery cells.

11. The battery pack as claimed in claim 1, wherein each of the plurality of battery cells is a cylindrical secondary battery.

12. A method of manufacturing a battery pack, the method comprising:
providing a plurality of battery cells;
electrically connecting an electrode tab in which a hole has been formed, which is defined at least in part by a portion of the electrode tab, and terminals of one or more battery cells of the plurality of battery cells; and
connecting a connection tab of a protection circuit module having a protection circuit formed therein and comprising a connection tab and the portion of the electrode tab,
wherein the connecting of the connection tab and the portion of the electrode tab comprises electrically connecting the portion of the electrode tab and the connection tab by soldering.

13. The method as claimed in claim 12, wherein the connecting of the connection tab and the portion of the electrode tab comprises connecting the portion of the electrode tab and the connection tab in a state in which the plurality of battery cells and the protection circuit module have been separated from each other.

14. The method as claimed in claim 13, wherein the connecting of the connection tab and the portion of the electrode tab comprises connecting the portion of the electrode tab and the connection tab in a state in which a mounting surface on which a plurality of chips of the protection circuit module is mounted has been disposed toward the plurality of battery cells.

15. The method as claimed in claim 14, further comprising connecting the protection circuit module and the connection tab by soldering so that a first soldering area is formed on a surface opposite to the mounting surface of the protection circuit module.

16. The method as claimed in claim 12, further comprising forming the electrode tab by bending a first metal tab connected to a battery cell once in a length direction of the battery cell and bending the first metal tab once again in a circumferential direction of the battery cell.

17. The method as claimed in claim 16, further comprising forming the electrode tab by bending a second metal tab connected to the protection circuit module once in a thickness direction of the protection circuit module and bending the second metal tab once again in a length direction of the protection circuit module.

18. The method as claimed in claim 17, wherein the connecting of the connection tab and the portion of the electrode tab comprises connecting the portion of the electrode tab and the connection tab by soldering so that a second soldering area is formed between the length direction of the battery cell and the length direction of the protection circuit module.

19. The method as claimed in claim 12, wherein the electrically connecting of the electrode tab to the terminals of the one or more battery cells, among the plurality of battery cells, comprises electrically connecting the electrode tab and the terminals of the one or more battery cells, among the plurality of battery cells, by soldering.

20. The method as claimed in claim 12, wherein the providing of the plurality of battery cells comprises mounting the plurality of battery cells on a spacer having a shape corresponding to a lateral shape of a mounted battery cell and supporting sides of the plurality of battery cells.
